(19) United States
(12) Patent Application Publication
(10) Pub. No.: US 2015/0055004 A1
(43) Pub. Date: Feb. 26, 2015

(54) ELECTRONIC DEVICE, RELATED INFORMATION DISPLAY METHOD AND PROGRAM

(71) Applicant: XACTI CORPORATION, Daito City, Osaka (JP)

(72) Inventor: Shiro Nakamura, Moriguchi City (JP)

(73) Assignee: XACTI CORPORATION, Daito City, Osaka (JP)

(21) Appl. No.: 14/387,271

(22) PCT Filed: Feb. 25, 2013
(86) PCT No.: PCT/JP2013/054693

§ 371 Date: Sep. 23, 2014

(30) Foreign Application Priority Data
Mar. 26, 2012 (JP) 2012-069782

(51) Int. Cl. H04N 5/232

(52) U.S. Cl. CPC H04N 5/23293; H04N 5/23216
USPC 348/333.02

(57) ABSTRACT

When a subject image is displayed on a display screen, and when there is a touch panel operation of touching a corner of the display region or a touch panel operation of sliding a finger from a corner of the display region toward the center, a related information image that gives the impression that the back surface of the subject image was turned over is generated and displayed in the corner, and the related information (photography parameter information, etc.) of the subject image is displayed in the related information image.

### TECHNICAL FIELD

The present invention relates to an electronic device such as a cellular telephone or an imaging device, and a method and program for displaying related information.

### BACKGROUND ART

In an imaging device that includes a display portion, or in an electronic device (such as a cellular telephone) that is fed with shot images from an imaging device, during the viewing of shot images as a display target image, the viewer sometimes wants to see related information associated with the display target image. Related information is, for example, shooting parameter information (information related to shooting conditions) including ISO sensitivity, shutter speed, focal length, aperture stop, etc. Today, electronic devices such as cellular telephones are often furnished with camera capabilities, and occasions are frequent on which, via communication or the like, images shot on another device are viewed on one's electronic device. However, camera capabilities vary from one device to another, and thus the shooting parameters used by the camera capabilities of an electronic device on which images are being viewed can differ from the shooting parameters used by the camera capabilities of another device. The difference is one of the factors that make the viewer want to see shooting parameter information.

According to a first conventional display method of displaying shooting parameters, the display region for the display target image is reduced to leave a blank space where to display shooting parameters. According to a second conventional display method of displaying shooting parameters, shooting parameters are displayed in a form superimposed (overlaid) on the display target image. For example, according to one conventional method, when a subject on the display screen is specified by a touch panel operation, shooting parameters that suit the type of the subject are displayed in a form superimposed on the display target image (see Patent Document 1 identified below).

### LIST OF CITATIONS

### Patent Literature

Patent Document 1: JP-A-2011-10273

### SUMMARY OF THE INVENTION

### Technical Problem

However, with the first conventional display method, the display target image is displayed in too small a size. On the other hand, with the second conventional display method relying on overlaid display, the display target image itself becomes less viewable. Although conventional methods of displaying related information have been discussed with focus placed on shooting parameter information, the above discussion equally applies to any related information other than shooting parameter information.

An object of the present invention is to provide an electronic device, and a method and a program for displaying related information, that make it easier to see information related to images.

### Means for Solving the Problem

According to one aspect of the present invention, an electronic device as an imaging device that acquires a target image by shooting, or as a device that is fed with the target image, includes: a display portion; a related information control portion which acquires related information associated with the target image; and an operation input portion which receives input of a predetermined operation. When the predetermined operation is input to the operation input portion while the target image is being displayed in a specific display region, the display portion displays the related information in place of a partial image of the target image in a partial display region inside the specific display region. The partial display region is composed of a display region inside a first geometrical figure formed by connecting together a first point, a second point, and a third point and a display region inside a second geometrical figure formed by connecting together the second point, the third point, and a fourth point. The related information being displayed in the display region inside the first geometrical figure.

With this configuration, it is possible to obtain a visual effect as if seeing the reverse side of a real photograph. This permits the viewer to intuitively recognize that the related information is information associated with the target image, and to easily see the related information. Moreover, since no overlaying as mentioned earlier is performed, it is possible to avoid making the target image itself less viewable.

More specifically, for example, of the first to fourth points, the first point can be closest to the center of the specific display region, the specific display region can be a rectangular region including a first side and a second side which intersect each other, the second and third points can be located on the first and second sides respectively, and the fourth point can be located at a corner of the specific display region where the first and second sides intersect each other.

For another example, when, as the predetermined operation, a first predetermined operation is input to the operation input portion while the target image is being displayed in the specific display region, the display portion can display, in a first partial display region as the partial display region, first related information as the related information in place of a first partial image as the partial image; and when a second predetermined operation is input to the operation input portion while the target image is being displayed in the specific display region, the display portion can display, in a second partial display region inside the specific display region, second related information in place of a second partial image of the target image. The second related information can be information related to the target image but different from the first related information, and is acquired by the related information control portion.

For another example, the first related information can include information related to a shooting condition of the target image, and the second related information can include information other than the information related to the shooting condition.

With this configuration, it is possible to see information related to shooting conditions and other information simultaneously or separately.

For another example, the operation input portion can also receive input of additional information, and when the additional information is input to the electronic device via the operation input portion, the related information control portion can add the additional information to the second related information.

With this configuration, it is possible to include the additional information in the second related information when the operator so desires.

In that case, for example, the second predetermined operation can include specification of a position on a display screen in the display portion; when the second predetermined operation is input to the operation input portion while the target image is being displayed in the specific display region, the display portion can display the second related information in the second partial display region as a display region corresponding to the specified position; when the input of the additional information is received, the input additional information can be displayed on the display portion, the related information control portion holding the display position of the additional information in association with the additional information; and after the input of the additional information, when the second predetermined operation is input to the operation input portion with a position corresponding to the held position specified while the target image is being displayed in the specific display region, the display portion can display the additional information.

Instead, for example, the second predetermined operation can include specification of a position on a display screen in the display portion; when the second predetermined operation is input to the operation input portion while the target image is being displayed in the specific display region, the display portion can display the second related information in the second partial display region as a display region corresponding to the specified position; when the input of the additional information is received, the input additional information can be displayed on the display portion; and after the input of the additional information, when the second predetermined operation is input to the operation input portion while the target image is being displayed in the specific display region, irrespective of the display position of the additional information at the time of receipt of the input of the additional information, the display portion can display the second related information including the additional information in the second partial display region.

For another example, the display portion can include a touch panel which functions as the operation input portion; the first predetermined operation can be an operation involving contact between the first partial display region and an operating member; and the second predetermined operation can be an operation involving contact between the second partial display region and the operating member.

For another example, the operation input portion can also receive input of additional information, and when the additional information is input to the electronic device via the operation input portion, the related information control portion can add the additional information to the related information.

With this configuration, it is possible to include the additional information in the related information when the operator so desires.

In that case, for example, the predetermined operation can include specification of a position on a display screen in the display portion; when the predetermined operation is input to the operation input portion while the target image is being displayed in the specific display region, the display portion can display the related information in the partial display region as a display region corresponding to the specified position; when the input of the additional information is received, the input additional information can be displayed on the display portion, the related information control portion holding a display position of the additional information in association with the additional information; and after the input of the additional information, when the predetermined operation is input to the operation input portion with a position corresponding to the held position specified while the target image is being displayed in the specific display region, the display portion can display the additional information.

Instead, for example, the predetermined operation can include specification of a position on a display screen in the display portion; when the predetermined operation is input to the operation input portion while the target image is being displayed in the specific display region, the display portion can display the related information in the partial display region as a display region corresponding to the specified position; when the input of the additional information is received, the input additional information can be displayed on the display portion; and after the input of the additional information, when the predetermined operation is input to the operation input portion while the target image is being displayed in the specific display region, irrespective of the display position of the additional information at the time of receipt of the input of the additional information, the display portion displays the related information including the additional information in the partial display region.

For another example, the related information can include information related to a shooting condition of the target image.

According to another aspect of the present invention, a related information display method for use in an electronic device including a display portion operable to display a target image obtained by shooting and an operation input portion which receives input of a predetermined operation includes: a related information acquiring step of acquiring related information associated with the target image; and a displaying step of displaying, when the predetermined operation is input to the operation input portion while the target image is being displayed in a specific display region on the display portion, the related information in place of a partial image of the target image in a partial display region inside the specific display region. The partial display region is composed of a display region inside a first geometrical figure formed by connecting together a first point, a second point, and a third point and a display region inside a second geometrical figure formed by connecting together the second point, the third point, and a fourth point. The related information is displayed in the display region inside the first geometrical figure.

According to yet another aspect of the present invention, a program is prepared that makes a computer perform the related information display method described above.

### Advantageous Effects of the Invention

According to the present invention, it is possible to provide an electronic device, and a method and a program for displaying related information, that make it easier to see information related to images.

### BRIEF DESCRIPTION OF DRAWINGS

FIG. 1 is a schematic overall block diagram of an imaging device according to a first embodiment of the present invention;

FIG. 2 is a block diagram of a user interface;

FIG. 3 is a schematic structure diagram of a touch panel;

FIG. 4 is a diagram showing an example of a target image;

FIG. 5A is a diagram showing a structure of an image file, and FIG. 5B is a diagram showing shooting parameter information;

FIG. 6 is a block diagram of blocks particularly involved in a distinctive display procedure;

FIG. 7A is a diagram showing a display screen, FIG. 7B is a diagram showing a specific display region, and FIG. 7C is a diagram showing the center and the four corners of a specific display region;

FIG. 8 is a diagram showing a standard display state on a display portion;

FIG. 9 is a diagram showing how a display portion appears when displaying basic information;

FIG. 10A is a diagram showing a partial display region (PR₁), FIG. 10B is a diagram showing a partial image (PI₁), and FIG. 10C is a diagram illustrating a shape of a partial display region (PR₁);

FIGS. 11A and 11B are diagrams showing a first and a second example, respectively, of a basic information image;

FIGS. 12A and 12B are diagrams showing a first and a second example, respectively, of an operation for displaying basic information;

FIG. 13 is a diagram showing how the amount of information displayed as basic information changes;

FIG. 14 is a diagram showing how a display portion appears when displaying memo information;

FIG. 15A is a diagram showing a partial display region (PR₂), FIG. 5B is a diagram showing a partial image (PI₂), and FIG. 15C is a diagram illustrating a shape of a partial display region (PR₂);

FIGS. 16A and 16B are diagrams showing a first and a second example, respectively, of a memo information image;

FIGS. 17A and 17B are diagrams showing a first and a second example, respectively, of an operation for displaying memo information;

FIG. 18 is a diagram showing how the amount of information displayed as memo information changes;

FIG. 19 is a diagram showing a plurality of regions on a display screen according to a second embodiment of the present invention;

FIGS. 20A, 20B, and 20C are diagrams showing a first, a second, and a third example, respectively, of a memo input display state according to the second embodiment of the present invention;

FIG. 21A is a diagram showing an additional information input position, and FIG. 21B is a diagram showing additional information, both according to the second embodiment of the present invention.

FIGS. 22A and 22B are diagrams showing how memo information is displayed according to the second embodiment of the present invention; and

FIG. 23 is a schematic overall block diagram of an electronic device according to a third embodiment of the present invention.

### DESCRIPTION OF EMBODIMENTS

Hereinafter, exemplary embodiments of the present invention will be described specifically with reference to the accompanying drawings. Among different drawings referred to, the same parts are identified by the same reference signs, and in principle no overlapping description of the same parts will be repeated. In the present specification, for simplicity's sake, symbols and signs referring to information, signals, physical quantities, states, members, etc. are occasionally used with the names of the corresponding information, signals, physical quantities, states, members, etc. omitted or abbreviated.

### First Embodiment

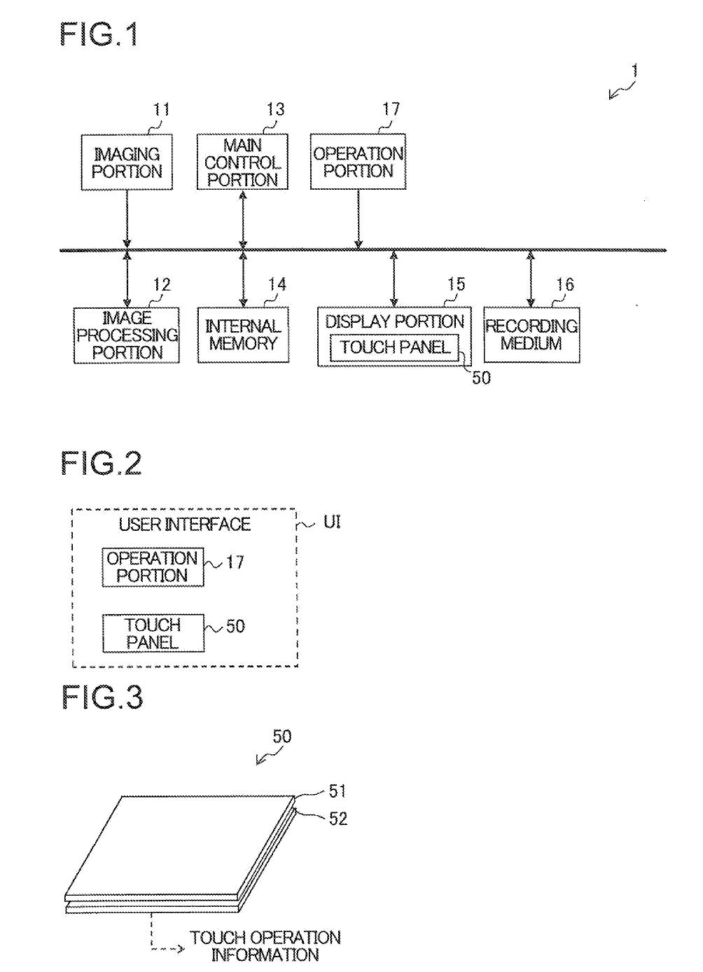

A first embodiment of the present invention will be described. FIG. 1 is a schematic overall block diagram of an imaging device 1 embodying the present invention. The imaging device 1 is a digital video camera capable of shooting and recording still and moving images, or a digital still camel capable of shooting and recording only still images. The imaging device 1 includes blocks identified by the reference signs 11 to 17.

An imaging portion 11 shoots an image of a subject within a shooting angle by use of an image sensor, and thereby acquires an image signal of a subject image as a shot image. The imaging portion 11 includes an optical system, an aperture stop, and an image sensor (solid-state image sensor) comprising a CCD (charge-coupled device) image sensor or a CMOS (complementary metal oxide semiconductor) image sensor, and the image sensor outputs the image signal of the subject image. An image processing portion 12 subjects the output image signal from the image sensor to predetermined image processing (for example, digitization, edge enhancement, noise reduction, and demosaicking), and thereby generates image data of the shot image based on the output image signal from the image sensor.

A main control portion 13 comprises a CPU (central processing unit) or the like, and controls the operation of different blocks within the imaging device 1 in a comprehensive fashion. An internal memory 14 comprises an SDRAM (synchronous dynamic random access memory) or the like, and temporarily stores various kinds of data generated within the imaging device 1. A display portion 15 comprises a display device having a display screen such as a liquid crystal display panel, and displays, under the control of the main control portion 13, various images including shot images and images recorded on a recording medium 16. The display portion 15 has a touch panel 50.

The recording medium 16 is a non-volatile memory such as a card-type semiconductor memory or a magnetic disk, and records, under the control of the main control portion 13, various kinds of data including image data of shot images. In the present description, recording, holding, and storing data all refers to the same operation. An operation portion 17 includes switches in the form of push buttons and the like, including a shutter release button for receiving an instruction to shoot a subject image, and accepts various operations from outside. Some buttons including the shutter release button can be implemented as buttons on the touch panel 50. An operator can, by making predetermined operations on the operation portion 17 or on the touch panel 50, feed various instructions to the imaging device 1. In the first embodiment, an operator denotes the operator (user) of the imaging device 1. As shown in FIG. 2, the operation portion 17 and the touch panel 50 constitute a user interface (operation input portion) UI which receives various operations and instructions from the operator. One of the operation portion 17 and the touch panel 50 can be omitted from the imaging device 1.

FIG. 3 is a schematic exploded view of the touch panel 50. The touch panel 50 includes a display screen 51 comprising a liquid crystal display panel or the like and a touch detector 52 which detects a position at which an operating member is touching (applying a pressure on) the display screen 51. An operating member is, for example, a finger or a pen, and in the following description it is assumed that an operating member is typically a finger. When an operating member is touching the display screen 51, the touch detector 52 outputs touch operation information indicating the position of the touch (hereinafter, touch position) on a real-time basis. The main control portion 13 can control different blocks within the imaging device 1 such that they operate according to the touch operation information. Operations that involve touching the display screen 51 with an operating member are referred to also as touch panel operations.

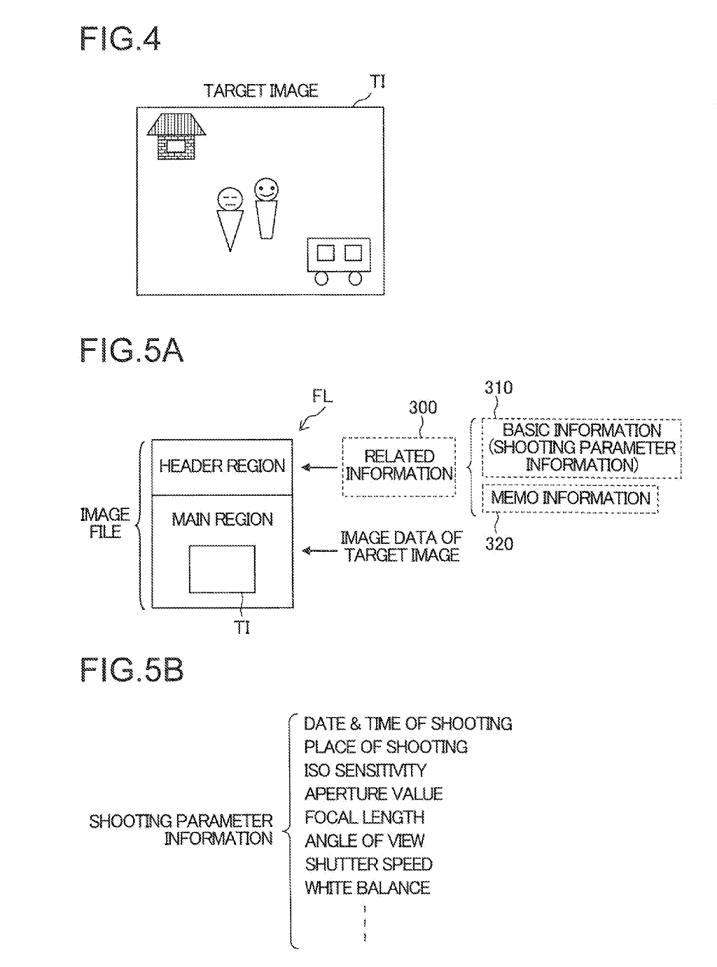

The recording medium 16 can record image data of shot images in a form stored in image files. FIG. 4 shows a target image TI as an example of a shot image recorded on the recording medium 16. The target image TI is a still image or a moving image. FIG. 5A shows a structure of one image file FL. The image file FL is composed of a main region and a header region. In the main region of the image file FL, the image data of the target image TI is stored, and in the header region, any related information 300 accompanying the target image TI can be stored. In the image file FL, the main region and the header region are associated with each other, and accordingly the target image TI (the image data of the target image TI) and the related information 300 are associated with each other. The related information 300 at least includes basic information 310, and can further include memo information 320.

The basic information 310 includes shooting parameter information which is information on the shooting conditions of the target image TI, and as shown in FIG. 5B, the shooting parameter information includes, for example, the date and time and the place of shooting of the target image TI, and the ISO (International Organization for Standardization) sensitivity, aperture value, focal length, angle of view, shutter speed, and white balance of the target image TI at the time of shooting. The basic information 310 can further include the file name of the image file FL and the image data of a thumbnail of the target image TI. The basic information 310 is, when the image data of the target image TI is recorded on the recording medium 16, recorded on the recording medium 16 together.

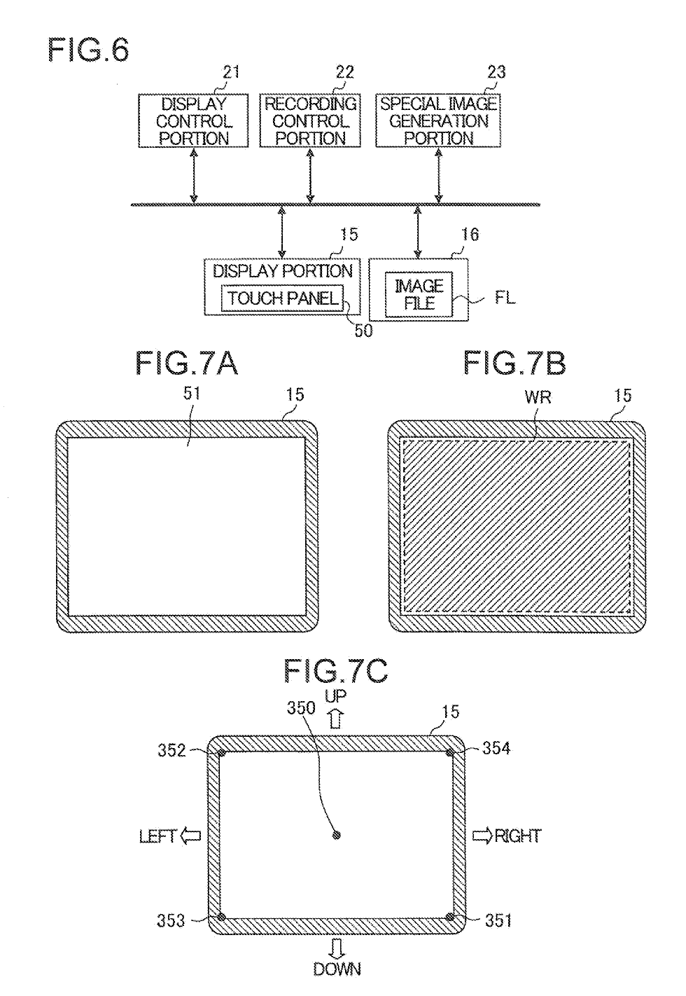

The memo information 320 can include any information other than information related to the shooting conditions of the target image TI. Using the user interface UI, the operator can include any information in the memo information 320. In other words, the main control portion 13 (for example, the later-described recording control portion 22; see FIG. 6) can write any information input via the user interface UI as the memo information 320 to the header region. The memo information 320 can be, when the image data of the target image TI is recorded on the recording medium 16, recorded on the recording medium 16 together. Also, after the image data of the target image TI is recorded on the recording medium 16, the operator can at any time input information to be included in the memo information 320 to the imaging device 1 via the user interface UI.

After the recording of the image file FL, the target image TI can be played back (that is, displayed) on the display portion 15, and during playback, the imaging device 1 can perform a distinctive display procedure. FIG. 6 is a block diagram of the blocks which are particularly involved in this distinctive display procedure. A display control portion 21 which controls the contents displayed on the display portion 15 and a recording control portion 22 which controls recording on the recording medium 16 can be provided in the main control portion 13. A special image generation portion (related information image generation portion) 23 can be provided in the main control portion 13 or in the image processing portion 12. The image generation portion 23 can be considered a component of the display control portion 21. In the following description, “display” refers to display on the display portion 15 (display screen 51) unless otherwise stated. The display control portion 21, the recording control portion 22, and the image generation portion 23 can freely read any data and information from the image file FL on the recording medium 16, and the recording control portion 22 can freely write any data and information to the image file FL on the recording medium 16. FIG. 7A is an exterior view of the display portion 15. In any diagram including FIG. 7A that shows the exterior view of the display portion 15, the part located around the edge of the display portion 15 and hatched with rightward descending diagonal strokes (an array of diagonal lines running from upper left to lower right) represents a housing part of the display portion 15.

When the target image TI is displayed on the display portion 15, the display control portion 21 can set a predetermined specific display region WR inside the entire display region of the display screen 51, and can use the entire specific display region WR to display the target image TI. In FIG. 7B, the part hatched with rightward ascending diagonal strokes (an array of diagonal lines running from lower left to upper right) represents the specific display region WR. The specific display region WR can coincide with the entire display region of the display screen 51, or can be part of the entire display region of the display screen 51. Here, it is assumed that the specific display region WR coincides with the entire display region of the display screen 51. It is also assumed that the target image TI is a rectangular image, and that the specific display region WR accordingly is a rectangular region. The target image TI can have an outline other than rectangular, and the specific display region WR can accordingly have an outline other than rectangular. In FIG. 7C, a point 350 represents the center of the specific display region WR, and points 351 to 354 represent the four corners of the rectangular region as the specific display region WR. When the display screen 51 is placed parallel to a vertical plane, as viewed from an operator standing right in front of the display screen 51, the lower-right, upper-left, lower-left, and upper-right corners of the specific display region WR correspond to the points 351, 352, 353, and 354 respectively.

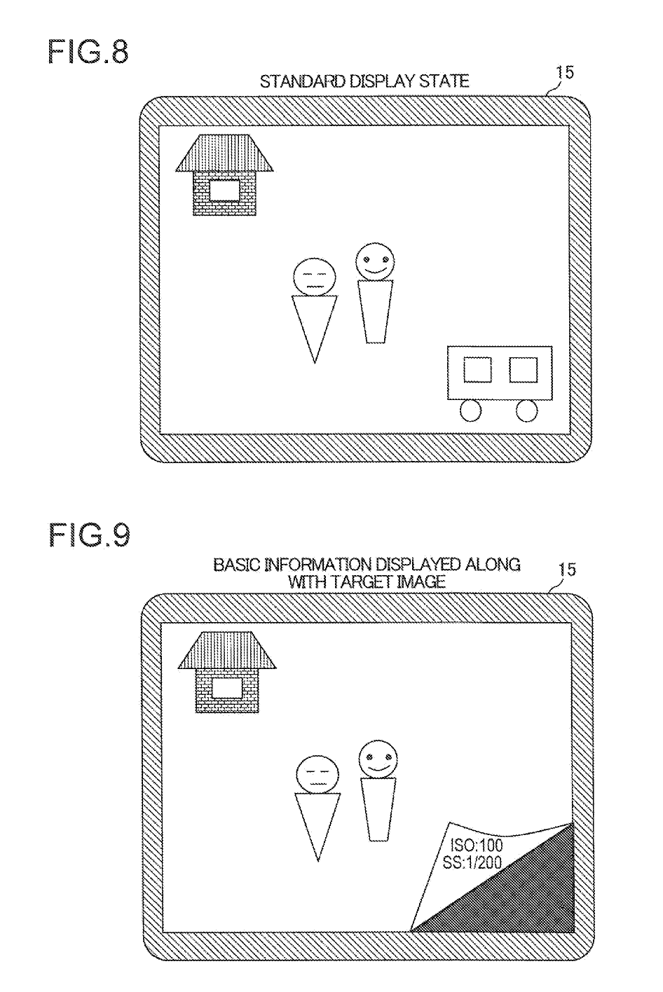

FIG. 8 shows a state where the entire target image TI is displayed in the specific display region WR (hereinafter referred to as the standard display state).

In the standard display state, when the operator makes a predetermined information display request operation OP₁ on the user interface UI (in other words, when the user interface UI receives input of an information display request operation OP₁), the display control portion 21 makes the image generation portion 23 generate a basic information image showing basic information 310, and displays, in a partial display region PR₁ which is part of the specific display region WR, the basic information image in place of a partial image PI₁ which is part of the target image TI (see FIGS. 9, 10A to 10C, 11A, etc.). FIG. 9 shows a display state of the display portion 15 during such display (that is, when a basic information image is being displayed).

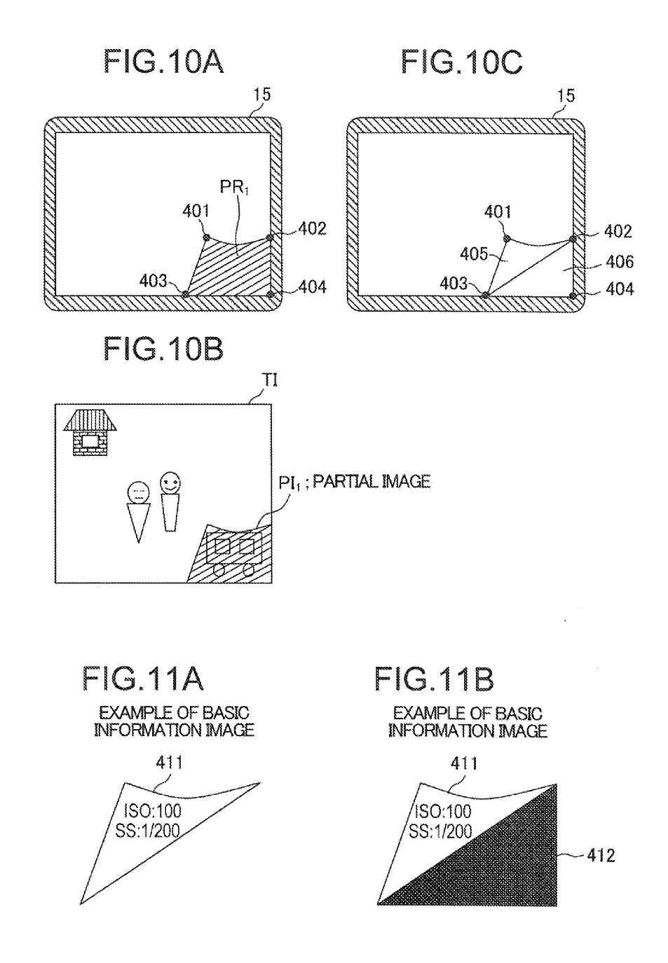

In FIG. 10A, the part of the display region hatched with rightward ascending diagonal lines is the partial display region PR₁. In FIG. 10B, the part of the image hatched with rightward ascending diagonal lines is the partial image PI₁. As shown in FIGS. 10A and 10C, the partial display region PR₁ is composed of a display region inside a main geometrical figure 405 formed by connecting together the points 401 to 403 and a display region inside a sub geometrical figure 406 formed by connecting together the points 402 to 404. With reference also to FIG. 7C, of the points 401 to 404, the point 401 is the closest to the center 350 of the specific display region WR. The point 402 is located on the side connecting between the points 351 and 354 (one side of the rectangular region as the specific display region WR), the point 403 is located on the side connecting between the points 351 and 353 (another side of the rectangular region as the specific display region WR), and the point 404 is located at where those two sides intersect each other, that is, at the lower-right corner (351) of the specific display region WR. In the main geometrical figure 405, for example, the points 401 and 403 can be connected together with a straight line, and so can the points 402 and 403; the points 401 and 402 can be connected together with a curved line. The sub geometrical figure 406 is, for example, a rectangular triangle.

FIG. 11A shows an image 411 which is an example of a basic information image. The outline of the image 411 coincides with the outline of the main geometrical figure 405, and all or part of the basic information 310 is displayed, in the form of a character string or a symbol, inside the image 411. However, as shown in FIG. 11B, the basic information image can be a composite image of the image 411 and an image 412. The outline of the image 412 coincides with the outline of the sub geometrical figure 406. The image 412 is, for example, a plain image painted solid in a single color. When the operation OP₁ is made, the display control portion 21 so controls as to display the image 411 in the display region inside the main geometrical figure 405 in the partial display region PR₁ and the image 412 in the display region inside the sub geometrical figure 406 in the partial display region PR₁. In principle, no basic information 310 is displayed in the image 412. However, with a view to displaying more information, part of the basic information 310 can be displayed also in the image 412 inside the sub geometrical figure 406 (that is, when the operation OP₁ is made, the entire partial display region PR¹ can be used to display the basic information 31).

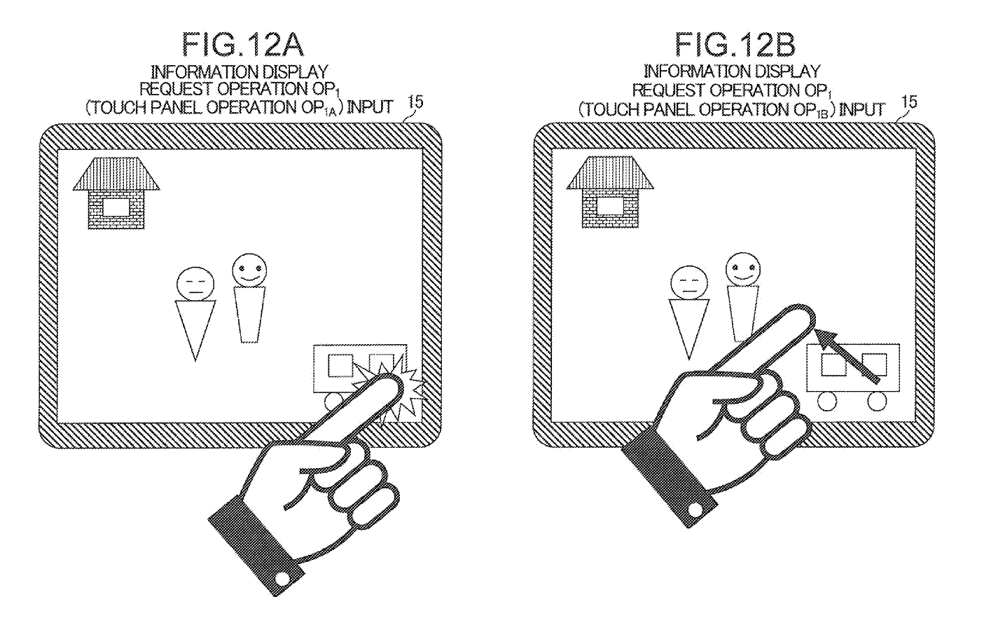

As shown in FIG. 12A, the information display request operation OP₁ is, for example, a touch panel operation OP_{1A} which involves touching a predetermined display region (for example, the partial display region PR₁) of the display screen 51 with an operating member. Or, as shown in FIG. 12B, the information display request operation OP₁ is a touch panel operation OP_{1B} which involves moving an operating member, while maintaining contact between the operating member and the display screen 51, in a predetermined direction (for example, in a direction including a directional component pointing from the point 351 to the point 350) inside a predetermined display region (for example, in the partial display region PR₁) of the display screen 51. Or, the operation OP₁ can be an operation on an operated member (key, button, dial, or the like) provided on the operation portion 17, in which case the operation OP₁ can be an operation specifying a position near the lower-right corner of the specific display region WR (for example, a position inside the partial display region PR₁) on the operation portion 17.

The basic information image functions as an image that imitates the reverse side of the target image TI. That is, the basic information image represents a virtual reverse side of a two-dimensional plane on the obverse side of which is arranged the target image TI. In response to input of the operation OP₁, the display control portion 21 and the image generation portion 23 display, as the basic information image, an animation (animated image) showing a lower-right part of the target image TI being gradually flipped up in the partial display region PR₁. Such an animation gives a visual effect as if seeing the reverse side of a real photograph; thus, by referring to the basic information image which looks like the reverse side of the target image TI, the operator can easily see the basic information 310 while intuitively recognizing that the basic information 310 is information associated with the target image TI. Moreover, the target image TI itself is not overlaid with the basic information 310, and this helps avoid making the target image TI less viewable.

The basic information 310 displayed in the basic information image is usually part of the basic information 310. When the operation OP₁ is a touch panel operation OP_{1B} (see FIG. 12B), the display control portion 21 and the image generation portion 23 can change the amount of information displayed as the basic information 310 in the partial display region PR₁ according to the distance over which the operating member is moved across the display screen 51 (touch panel 50) while contact is maintained between the operating member and the display screen 51 (in other words, between the operating member and the touch panel 50).

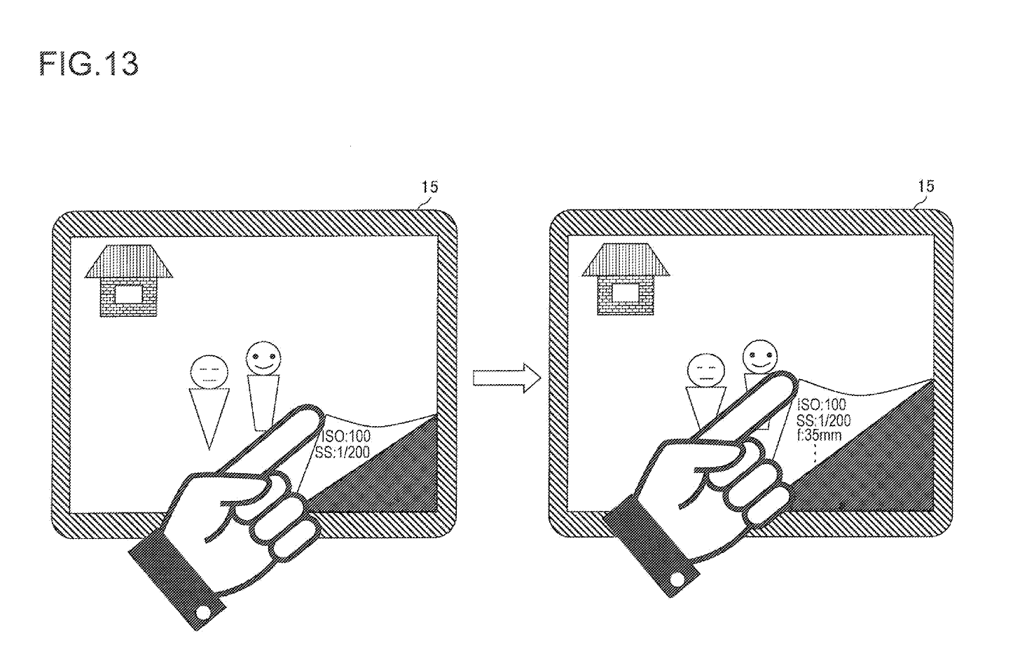

More specifically, for example, as shown in FIG. 13, as the above-mentioned distance in the touch panel operation OP_{1B} increases, the display control portion 21 can increase the size of the partial display region PR₁, and the image generation portion 23 can increase the size of the basic information image. As the size of the basic information image is increased, the image generation portion 23 can increase the amount of information displayed as the basic information 310 in the basic information image. Such increase can be done in steps, namely in any number of steps equal to or greater than 2. Through such a display procedure, it is possible to obtain an effect as if flipping over a page of a book.

In a case where display is controlled in two steps, the control can proceed as follows. For example, when the above-mentioned distance in the touch panel operation OP_{1B} equals a first distance, the information displayed in the basic information image can be an abridged version of the basic information 310, and when the above-mentioned distance in the touch panel operation OP_{1B} equals a second distance greater than the first distance, the information displayed in the basic information image can be a fuller version of the basic information 310. An abridged version of the basic information 310 is part of the basic information 310. A fuller version of the basic information 310 is part or all of the basic information 310, includes the entire abridged version of the basic information 310, and includes more information than the abridged version of the basic information 310. What part of the basic information 310 to include in the abridged version of the basic information 310, and what part of the basic information 310 to include in the fuller version of the basic information 310, can be determined beforehand.

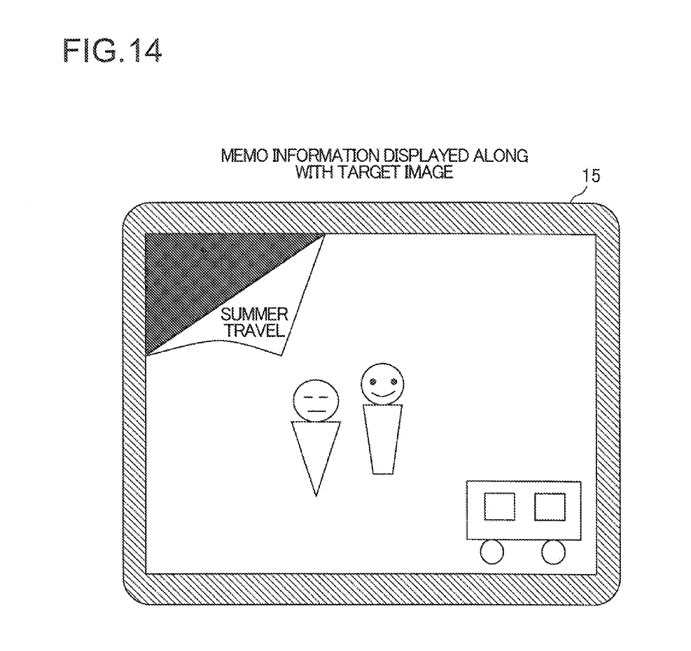

On the other hand, in the standard display state, when the operator makes a predetermined information display request operation OP₂ on the user interface UI (in other words, when the user interface UI receives input of an information display request operation OP₂), the display control portion 21 makes the image generation portion 23 generate a memo information image showing memo information 320, and displays, in a partial display region PR₂ which is part of the specific display region WR, the memo information image in place of a partial image PI₂ which is part of the target image TI (see FIGS. 14, 15A to 15C, 16A, etc.). FIG. 14 shows a display state of the display portion 15 during such display (that is, when a memo information image is being displayed).

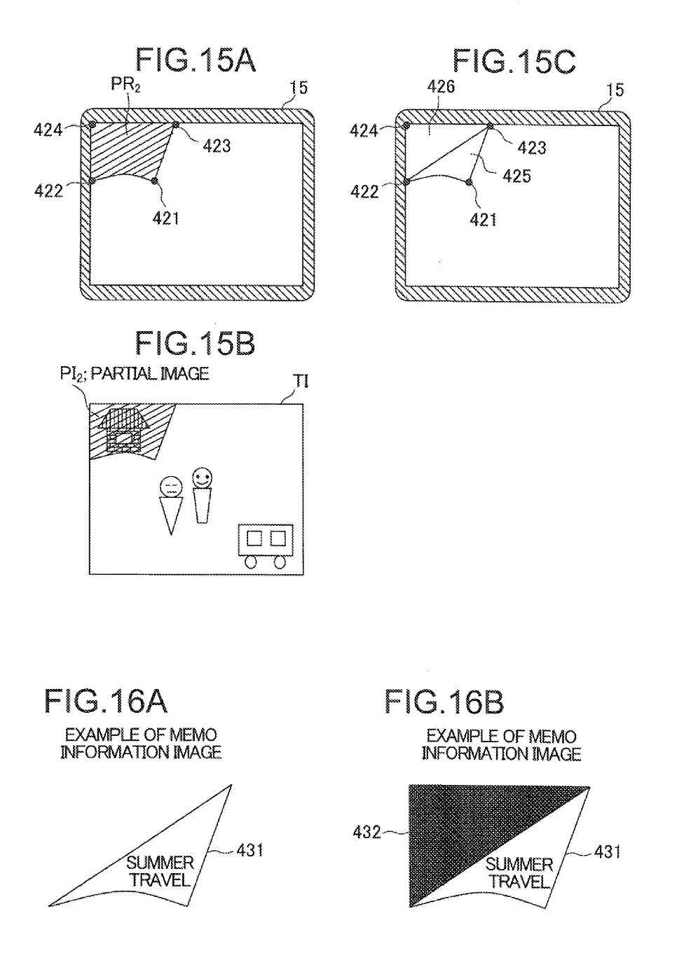

In FIG. 15A, the part of the display region hatched with rightward ascending diagonal lines is the partial display region PR₂. In FIG. 15B, the part of the image hatched with rightward ascending diagonal lines is the partial image PI₂. As shown in FIGS. 15A and 15C, the partial display region PR₂ is composed of a display region inside a main geometrical figure 425 formed by connecting together the points 421 to 423 and a display region inside a sub geometrical figure 426 firmed by connecting together the points 422 to 424. With reference also to FIG. 7C, of the points 421 to 424, the point 421 is the closest to the center 350 of the specific display region WR. The point 422 is located on the side connecting between the points 352 and 353 (one side of the rectangular region as the specific display region WR), the point 423 is located on the side connecting between the points 352 and 354 (another side of the rectangular region as the specific display region WR), and the point 424 is located at where those two sides intersect each other, that is, at the upper-left corner (352) of the specific display region WR. In the main geometrical figure 425, for example, the points 421 and 423 can be connected together with a straight line, and so can the points 422 and 423; the points 421 and 422 can be connected together with a curved line. The sub geometrical figure 426 is, for example, a rectangular triangle.

FIG. 16A shows an image 431 which is an example of a memo information image. The outline of the image 431 coincides with the outline of the main geometrical figure 425, and all or part of the memo information 320 is displayed, in the form of a character string or a symbol, inside the image 431. However, as shown in FIG. 16B, the memo information image can be a composite image of the image 431 and an image 432. The outline of the image 432 coincides with the outline of the sub geometrical figure 426. The image 432 is, for example, a plain image painted solid in a single color. When the operation OP₂ is made, the display control portion 21 so controls as to display the image 431 in the display region inside the main geometrical figure 425 in the partial display region PR₂ and the image 432 in the display region inside the sub geometrical figure 426 in the partial display region PR₂. In principle, no memo information 320 is shown in the image 432. However, with a view to displaying more information, part of the memo information 320 can be displayed also in the image 432 inside the sub geometrical figure 426 (that is, when the operation OP₂ is made, the entire partial display region PR₂ can be used to display the memo information 320).

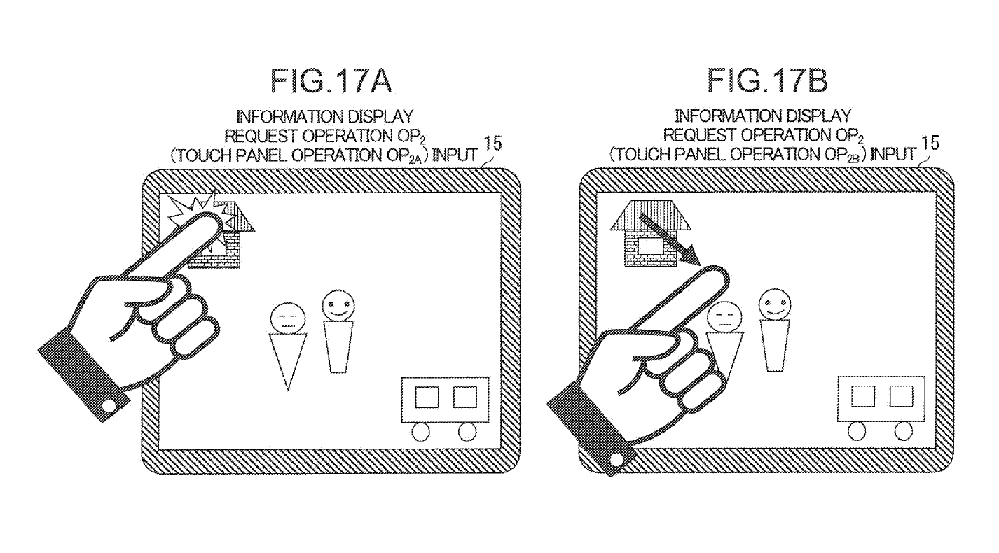

As shown in FIG. 17A, the information display request operation OP₂ is, for example, a touch panel operation OP_{2A} which involves touching a predetermined display region (for example, the partial display region PR₂) of the display screen 51 with an operating member. Or, as shown in FIG. 17B, the information display request operation OP₂ is a touch panel operation OP_{2B} which involves moving an operating member, while maintaining contact between the operating member and the display screen 51, in a predetermined direction (for example, in a direction including a directional component pointing from the point 352 to the point 350) inside a predetermined display region (for example, in the partial display region PR₂) of the display screen 51. Or, the operation OP₂ can be an operation on an operated member (key, button, dial, or the like) provided on the operation portion 17, in which case the operation OP₂ can be an operation specifying a position near the upper-left corner of the specific display region WR (for example, a position inside the partial display region PR₂) on the operation portion 17.

Like the basic information image, the memo information image functions as an image that imitates the reverse side of the target image TI. That is, the memo information image represents a virtual reverse side of a two-dimensional plane on the obverse side of which is arranged the target image TI. In response to input of the operation OP₂, the display control portion 21 and the image generation portion 23 display, as the memo information image, an animation showing an upper-left part of the target image TI being gradually flipped up in the partial display region PR₂. Such an animation gives a visual effect as if seeing the reverse side of a real photograph; thus, by referring to the memo information image which looks like the reverse side of the target image TI, the operator can easily see the memo information 320 while intuitively recognizing that the memo information 320 is information associated with the target image TI. Moreover, the target image TI itself is not overlaid with the memo information 320, and this helps avoid making the target image TI less viewable.

The memo information 320 displayed in the memo information image is usually part of the memo information 320. When the operation OP₂ is a touch panel operation OP_{2B} (see FIG. 17B), the display control portion 21 and the image generation portion 23 can change the amount of information displayed as the memo information 320 in the partial display region PR₂ according to the distance over which the operating member is moved across the display screen 51 (touch panel 50) while contact is maintained between the operating member and the display screen 51 (in other words, between the operating member and the touch panel 50).

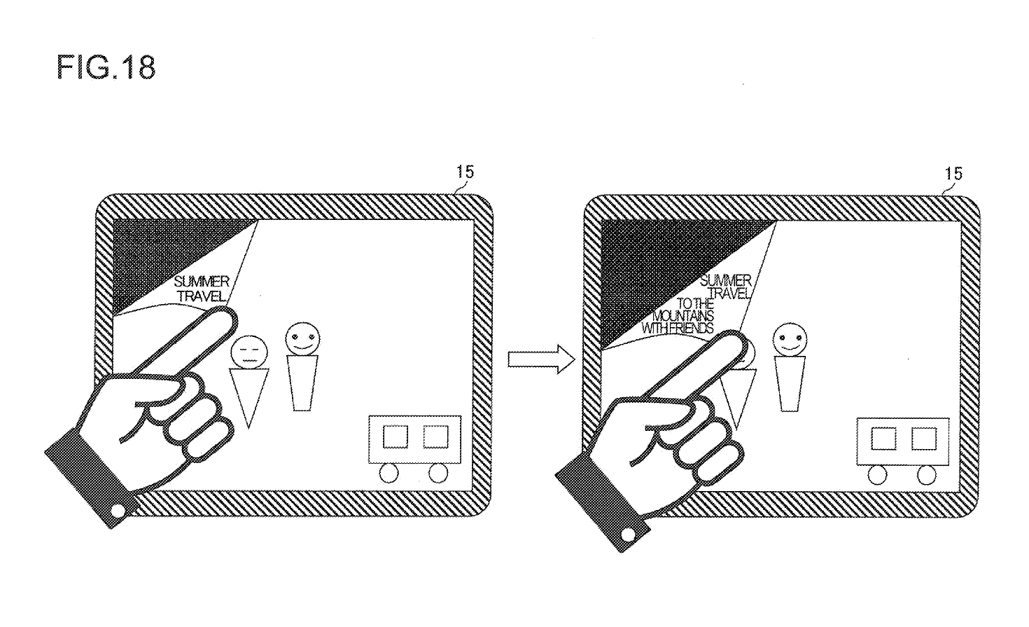

More specifically, for example, as shown in FIG. 18, as the above-mentioned distance in the touch panel operation OP_{2B} increases, the display control portion 21 can increase the size of the partial display region PR₂, and the image generation portion 23 can increase the size of the memo information image. As the size of the memo information image is increased, the image generation portion 23 can increase the amount of information displayed as the memo information 320 in the memo information image. Such increase can be done in steps, namely in any number of steps equal to or greater than 2. Through such a display procedure, it is possible to obtain an effect as if flipping over a page of a book.

In a case where display is controlled in two steps, the control can proceed as follows. For example, when the above-mentioned distance in the touch panel operation OP_{2B} equals a first distance, the information displayed in the memo information image can be an abridged version of the memo information 320, and when the above-mentioned distance in the touch panel operation OP_{2B} equals a second distance greater than the first distance, the information displayed in the memo information image can be a fuller version of the memo information 320. An abridged version of the memo information 320 is part of the memo information 320. A fuller version of the memo information 320 is part or all of the memo information 320, includes the entire abridged version of the memo information 320, and includes more information than the abridged version of the memo information 320. What part of the memo information 320 to include in the abridged version of the memo information 320, and what part of the memo information 320 to include in the fuller version of the memo information 320, can be determined beforehand.

As will be understood from the above description, the operations OP₁ and OP₂ are mutually different operations, the basic information 310 and the memo information 320 are mutually different information, the basic information image and the memo information image are mutually different images, the partial display regions PR₁ and PR₂ are mutually different display regions, and the partial images PI₁ and PI₂ are mutually different partial images.

Incidentally, after the image file FL containing the image data of the target image TI is recorded on the recording medium 16, the user interface UI can at any time accept a memo addition operation from the operator. A memo addition operation is an operation for inputting additional information to be added to the memo information 320 to the imaging device 1. A memo addition operation can be accepted while a memo information image is being displayed in the partial display region PR₂.

When a memo addition operation is made on the user interface UI (in other words, when additional information is input to the imaging device 1 via the user interface UI), the recording control portion 22 adds the additional information input by the memo addition operation to the memo information 320 in the header region of the image file FL (additionally write the additional information to the header region so that the additional information is included in the memo information 320), and in this way the image generation portion 23 can correct the memo information image. That is, when a memo addition operation is made on the user interface UI, the image generation portion 23 can correct the memo information image such that the memo information image shows the memo information 320 that includes the additional information. In some cases, however, no such correction is made in the memo information image. Depending on the total amount of information in the memo information 320, it can be impossible to show the additional information included in the memo information 320 in the memo information image. The image generation portion 23 can also generate a memo information image such that additional information is shown in the memo information image in preference to the memo information 320 that is written to the header region at the time of the recording of the image file FL on the recording medium 16.

Although in the above example the basic information image and the memo information image are displayed respectively in a lower-right region and an upper-left region of the specific display region WR, the basic information image can instead be displayed in a lower-left, upper-left, or upper-right region of the specific display region WR, and the memo information image can be displayed in an upper-right, lower-right, or lower-left region of the specific display region WR.

If the partial image PI₁ or PI₂, which is supposed to stop being displayed in response to an operation OP₁ or OP₂, is an important part of the image (a part of the image which the operator wants to see along with the basic information 310 or the memo information 320), the operator can change the display position of the basic information image or the memo information image away from the position mentioned above. For example, if the operator considers the partial image PI₁ an important part of the image, the operator can make a touch panel operation which involves touching the specific display region WR near its lower-left corner, in which case the imaging device 1 can so control as to display the basic information image in a lower-left region of the specific display region WR (the memo information image can be handled in a similar manner).

### Second Embodiment

A second embodiment of the present invention will now be described. Any part of the following description of the second embodiment is equally applicable to the first embodiment.

As will be understood from the description of the first embodiment, the information display request operation OP₂ includes specification of a position on the display screen 51; thus when, in the standard display state (see FIG. 8), an operation OP₂ is input to the user interface UI, under the control of the display control portion 21, the display portion 15 displays a memo information image in a display region corresponding to the position specified in the operation OP₂. The position specified in an operation OP₂ can be considered a position with a size (hence, a region). In the first embodiment, it is particularly assumed that the position specified in an operation OP₂ corresponds to the partial display region PR₂, with the result that the memo information image is displayed in place of the partial image PI₂ in the partial display region PR₂ corresponding to the specified position (see FIGS. 14, 15A, 15B, and 16B).

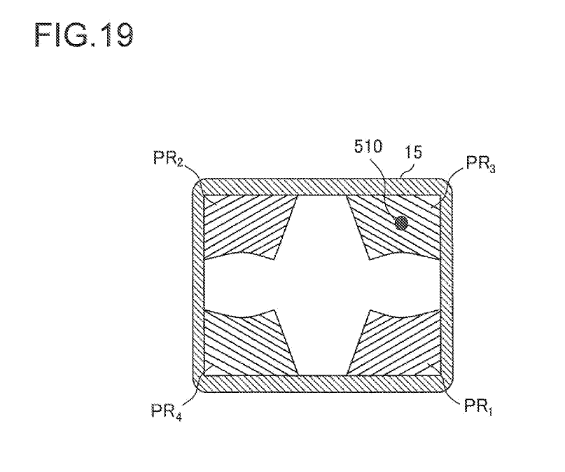

As opposed to the above assumption, when, in the standard display state, an operation OP₂ is input to the user interface UI, if the position specified in the operation OP₂ is a position 510 in FIG. 19 and in addition the specified position 510 is a position inside a partial display region PR₃, the memo information image is displayed in place of a partial image PI₃ in the partial display region PR₃. A partial image PIᵢ (where i is any integer) refers to an image which is part of the target image TI and which is displayed in a partial display region PRᵢ in the standard display state. Regions PR₁ to PR₄ are each part of the specific display region WR (see FIG. 7B), and are mutually different regions. The regions PR₁ to PR₄ are located respectively in a lower-right, an upper-left, an upper-right, and a lower-left part of the specific display region WR. The regions PR₁ to PR₄ can have mutually different shapes; here, however, it is assumed that, with respect to a vertical line across the display screen 51 through the center of the display screen 51, the regions PR₂ and PR₃ are in a line-symmetric relationship with each other, and the regions PR₁ and PR₄ are in a line-symmetric relationship with each other.

The following description of the second embodiment deals with an example of technology related to the memo addition operation mentioned above, assuming that the image file FL containing the image data of the target image TI has been recorded on the recording medium 16.

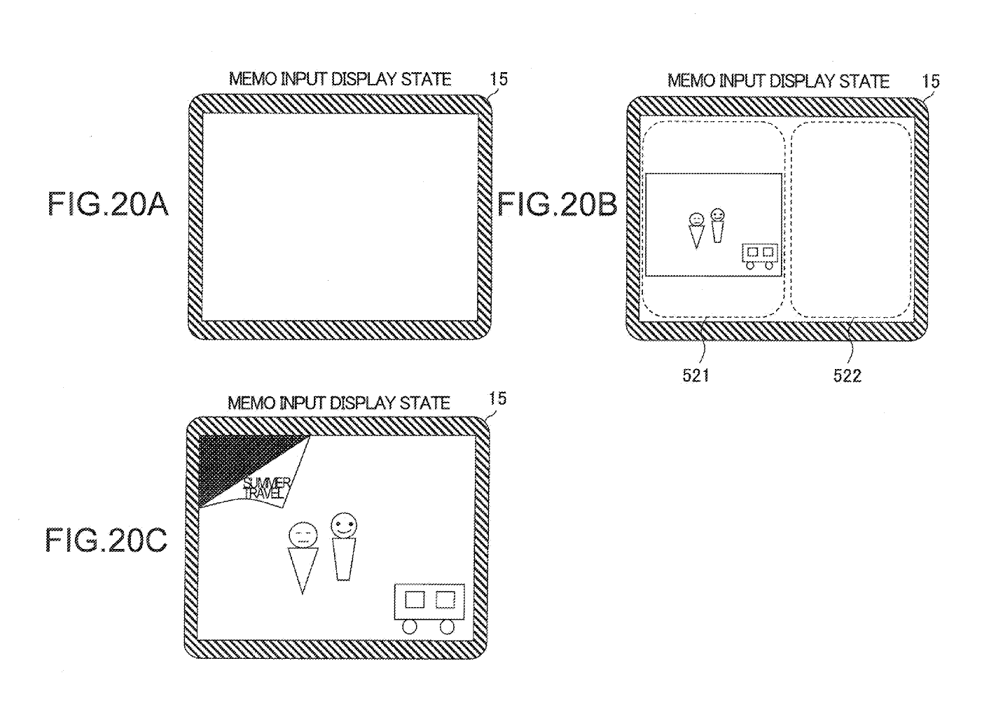

For example, in the standard display state (see FIG. 8), when a predetermined operation is input to the user interface UI, the display control portion 21 changes the display state on the display portion 15 to a memo input display state for accepting an memo addition operation. As shown in FIG. 20A, in the memo input display state, for example, an image that imitates the entire reverse side of the target image TI (such as a plain image painted in a single color like the reverse side of a photograph on paper) is displayed on the display portion 15. Or, for example as shown in FIG. 20B, the memo input display state can be a state where the target image TI is displayed in, of mutually different display regions 521 and 522 set in the entire display region of the display screen 51, the display region 521. In the example shown in FIG. 20B, the display region 522 is the space for writing and displaying additional information. Or, for another example as shown in FIG. 20C, the memo input display state can be a state where, as described in connection with the first embodiment, the target image TI is displayed in the specific display region WR (see FIG. 7B) in response to input of an information display request operation OP₂ while a memo information image is displayed in place of a partial image PIᵢ in a partial display region PRᵢ.

Needless to say, what has been specifically discussed above is not meant to limit the contents displayed on the display screen 51 in the memo input display state. In the following description, however, for the sake of concrete description, it is assumed that the display state of the display portion 15 when accepting a memo addition operation is the memo input display state shown in FIG. 20A or 20C. When changing the display state of the display portion 15 from the standard display state shown in FIG. 8 to the memo input display state shown in FIG. 20A, the display control portion 21 can display an animation as if a photograph as the target image TI being flipped over.

In a memo addition operation, the operator can specify, via the user interface UI, a position at which to input additional information on the display screen 51 (hereinafter referred to as the additional information input position). An additional information input position corresponds to a display position of additional information, and the additional information input by a memo addition operation is displayed, under the control of the display control portion 21, at the additional information input position.

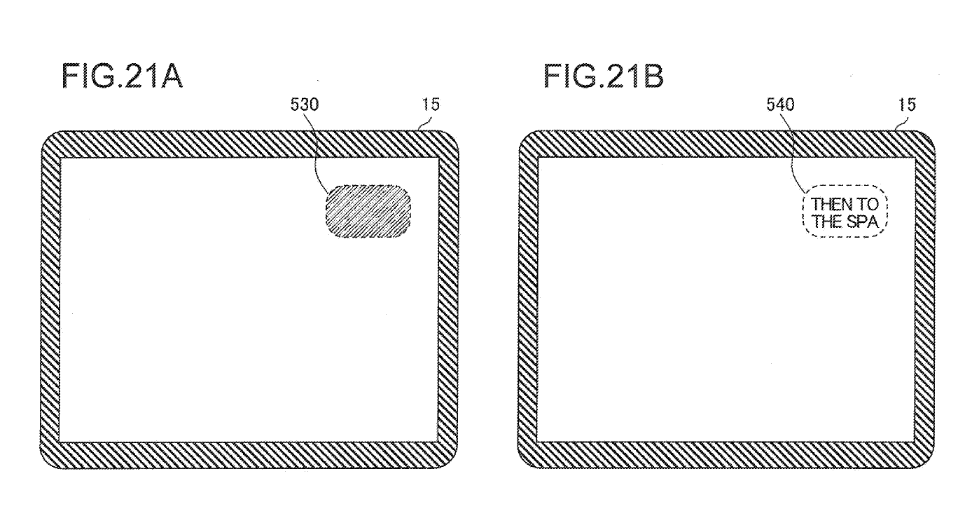

Suppose now that, in a memo addition operation, a position 530 in FIG. 21A is specified as an additional information input position and additional information 540 in FIG. 21B is input to the imaging device 1. It should be noted that, like a position specified in an operation OP₂, an additional information input position can be considered a position with a size (hence, a region). The display control portion 21 so controls that the input additional information 540 is displayed at the additional information input position 530 (see FIGS. 21A and 21B). On the other hand, the recording control portion 22 writes to (that is, holds in) the header region of the image file FL of the target image TI (see FIG. 5B) the display position of the additional information 540 at the time of receipt of its input (that is, the additional information input position 530) in association with the additional information 540. Although in FIG. 21A the position 530 is recognized as a region, any point inside the display region where the additional information 540 is displayed can instead be considered the position 530.

After the input of the additional information 540, when an operation OP₂ is input to the user interface UI in the standard display state, the display control portion 21 can perform first display control or second display control as described below.

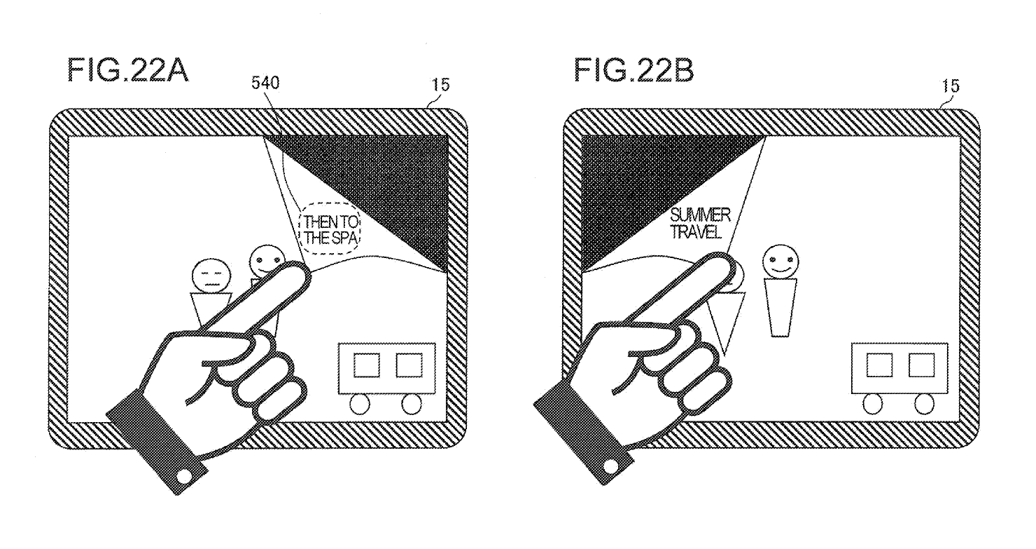

For example, in the first display control, when the held additional information input position 530 lies inside a partial display region PR₃, if, as shown in FIG. 22A, the position specified in the operation OP₂ corresponds to the partial display region PR₃, the additional information 540 is displayed in that partial display region PR₃ but, if, as shown in FIG. 22B, the position specified in the operation OP₂ does not correspond to the partial display region PR₃, the additional information 540 is not displayed (in FIG. 22B, the position specified in the operation OP₂ corresponds to the partial display region PR₂).

Specifically, the control proceeds as follows. In the first display control, the display control portion 21 refers to the display position 530 written to the above-mentioned header region in association with the additional information 540 (that is, the held additional information input position). In the first display control, if the position specified in the operation OP₂ after the input of the additional information 540 corresponds to the held position (the held additional information input position) 530, the display control portion 21 displays memo information including the additional information 540 at the position specified in the operation OP₂, but, if the position specified in the operation OP₂ after the input of the additional information 540 does not correspond to the held position 530, the display control portion 21 displays memo information that does not include the additional information 540 at the position specified in the operation OP₂ (that is, the additional information 540 is not displayed). For example, when there is an overlap between the position specified in the operation OP₂ and the held position 530, or when the distance between the position specified in the operation OP₂ and the held position 530 is equal to or smaller than a predetermined distance, the position specified in the operation OP₂ is found to correspond to the held position 530; when there is no overlap between the position specified in the operation OP₂ and the held position 530, or when the distance between the position specified in the operation OP₂ and the held position 530 is greater than a predetermined distance, the position specified in the operation OP₂ is found not to correspond to the held position 530.

As described above, in the first display control, when an operation OP₂ is input to the user interface UI with a position corresponding to the held position 530 specified, the additional information 540 is displayed in a display region corresponding to the position specified in the operation OP₂ (a display region corresponding to the held position 530). Thus, the operator feels as if seeing a memo (the additional information 540) written on the reverse side of a real photograph on paper.

By contrast, in the second display control, irrespective of the display position of the additional information 540 at the time of receipt of input of the additional information 540 (that is, the additional information input position 530), when an operation OP₂ is input to the user interface UI, the display control portion 21 displays memo information including the additional information 540 at the position specified in the operation OP₂ (for example, in the region PR₂ or PR₃). That is, for example, when the additional information input position 530 lies inside the partial display region PR₃, even if the position specified in the operation OP₂ does not correspond to the partial display region PR₃ (for example, if the position specified in the operation OP₂ corresponds to the region PR₂), in the second display control, the additional information 540 is displayed in the region PR₁ corresponding to the position specified in the operation OP₂. In the second display control, even if the operator forgets the input position of the additional information 540, he has only to make an operation OP₂ to see the additional information 540. In a case where the second display control is adopted, there is no need to write the additional information input position 530 to the header region.

### Third Embodiment

A third embodiment of the present invention will be described. The third embodiment is an embodiment based on the first and second embodiments, and unless inconsistent, any part of the description of the first and second embodiments applies equally to the third embodiment with respect to features for which no specific description is given in connection with the third embodiment.

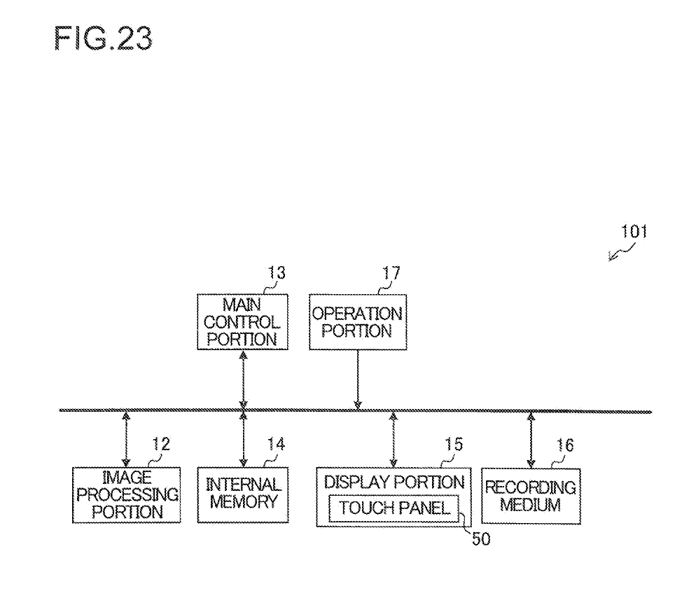

A procedure including a display procedure as described above in connection with the first and second embodiments can be performed in any electronic device other than an imaging device 1. Specifically, for example, an electronic device 101 as shown in FIG. 23 can be built. The electronic device 101 is a cellular telephone, information terminal device, personal computer, or the like. Needless to say, an imaging device 1 is a kind of electronic device. In applying the description of the first and second embodiments to the third embodiment, the term “imaging device 1” in the description of the first or second embodiment is to be read as “electronic device 101” wherever appropriate. As shown in FIG. 23, the electronic device 101 can include an image processing portion 12, a main control portion 13, an internal memory 14, a display portion 15 including a touch panel 50, a recording medium 16, and an operation portion 17 like those shown in FIG. 1. Also in the electronic device 101, the operation portion 17 and the touch panel 50 constitute a user interface UI (see FIG. 2). The electronic device 101 can include a display control portion 21, a recording control portion 22, and a special image generation portion 23 like those shown in FIG. 6. The electronic device 101 can even include an imaging portion similar to the imaging portion 11.

The electronic device 101 can, when fed with an image file FL containing image data of a target image TI from an imaging device 1, perform the same image generation and display as the imaging device 1 can. The electronic device 101 can receive the image file FL containing the image data of the target image TI captured by the imaging device 1 via wired or wireless communication, or via any server device, or via any recording medium, and can store the received image file FL on the recording medium 16 or the internal memory 14 within the electronic device 101. The recording medium 16 or the internal memory 14 can be referred to as a memory portion.

Cellular telephones and the like that function as the electronic device 101 are often furnished with camera capabilities, and occasions are frequent on which, via communication or the like, images captured on another device are viewed on the electronic device 101. On the other hand, camera capabilities vary from one device to another, and thus the shooting parameters of images shot on a device (for example, an imaging device 1) other than the electronic device 101 can differ from shooting parameters obtained by use of the camera capabilities of the electronic device 101. Accordingly, an operator of the electronic device 101 (an image viewer) often wants to see shooting parameter information while viewing images shot on another device (for example, an imaging device 1) on the electronic device 101. The display of a basic information image according to the present embodiment constitutes a useful technology to meet such demands.

### Variations and Modifications

Embodiments of the present invention allow for many variations and modifications within the spirit and scope of the technical concepts recited in the appended claims. The embodiments described above merely present examples of how the present invention can be implemented, and the senses of the terms used to describe the present invention and its features are not limited to those in which the terms are used in the description of the embodiments. Any specific values mentioned in the above description are merely examples, and, needless to say, can be changed to many different values. As notes applicable to the embodiments described above, notes 1 to 4 are given below. Unless inconsistent, any of the notes below can be combined with any other.

### [Note 1]

Although not so illustrated in FIGS. 1 and 23, the imaging device 1 or the electronic device 101 can include a microphone portion comprising a microphone. In a case where information to be included in the memo information 320 or in the additional information is speech, the operator can utter it into the microphone portion so that the speech will be included in the memo information 320 or in the additional information. More specifically, for example, an acoustic signal processing portion (not shown) for converting an acoustic signal of speech collected by the microphone portion into a character string through well-known voice recognition processing can be provided in the imaging device 1 or the electronic device 101. The recording control portion 22 in the imaging device 1 or the electronic device 101 can then write the character string, as memo information 320 or as additional information to be added to memo information 320, to the header region of the image file FL. In that case, the microphone portion can constitute, as a block for receiving input of speech, part of the user interface UI.

### [Note 2]

The association between the image data of the target image TI and the corresponding related information 300 can be in any other form than specifically described above. So long as the two are associated with each other, the image data of the target image TI and the corresponding related information 300 can be stored in separate files.

### [Note 3]

An electronic device (for example, an imaging device 1 or an electronic device 101) according to the present invention can be considered to include a related information control portion (not shown) for acquiring related information 300 associated with the target image TI. The related information control portion can include the special image generation portion 23 (see FIG. 6), and can further include all or part of the main control portion 13 (in particular, for example, the display control portion 21 and/or the recording control portion 22). The related information control portion can acquire related information 300 from the image file FL (see FIG. 5A), and can be so configured as to generate and record related information 300.

### [Note 4]

The imaging device 1 and the electronic device 101 can each be implemented in hardware or in a combination of hardware and software. In a case where the imaging device 1 or the electronic device 101 is implemented in software, a block diagram showing blocks implemented in software is a functional block diagram of those blocks. Functions implemented in software can be prepared as a program so that those functions are executed when the program is run on a program execution device (for example, a computer).

In particular, for example, an operation input function for receiving input of an operation to the user interface UI (operation input portion), a related information control function for acquiring, generating, and correcting related information (including adding of additional information to the memo information 320), and a display control function for displaying the target image TI and for displaying the basic information 310 and the memo information 320 through display of an basic information image and a memo information image can be prepared as a program, which can then be stored in a flash memory that can be incorporated in the main control portion 13 or a recording medium 16, and the program can be run on a computer (for example, a microprocessor that can be incorporated in the main control portion 13) to execute those functions.

### DESCRIPTION OF REFERENCE SIGNS

1 imaging device
11 imaging portion
13 main control portion
15 display portion
21 display control portion
22 recording control portion
23 special image generation portion
50 touch panel
51 display screen
101 electronic device
FL image file
UI user interface

1. An electronic device as an imaging device that acquires a target image by shooting or as a device that is fed with the target image, the electronic device comprising:
a display portion;
a related information control portion which acquires related information associated with the target image; and
an operation input portion which receives input of a predetermined operation,
wherein
when the predetermined operation is input to the operation input portion while the target image is being displayed in a specific display region, the display portion displays the related information in place of a partial image of the target image in a partial display region inside the specific display region, and
the partial display region is composed of a display region inside a first geometrical figure formed by connecting together a first point, a second point, and a third point and a display region inside a second geometrical figure formed by connecting together the second point, the third point, and a fourth point, the related information being displayed in the display region inside the first geometrical figure.

2. The electronic device according to claim 1, wherein
of the first to fourth points, the first point is closest to a center of the specific display region,
the specific display region is a rectangular region including a first side and a second side which intersect each other,
the second and third points are located on the first and second sides respectively, and
the fourth point is located at a corner of the specific display region where the first and second sides intersect each other.

3. The electronic device according to claim 1, wherein
when, as the predetermined operation, a first predetermined operation is input to the operation input portion while the target image is being displayed in the specific display region, the display portion displays, in a first partial display region as the partial display region, first related information as the related information in place of a first partial image as the partial image,
when a second predetermined operation is input to the operation input portion while the target image is being displayed in the specific display region, the display portion displays, in a second partial display region inside the specific display region, second related information in place of a second partial image of the target image, and
the second related information is information related to the target image but different from the first related information, and is acquired by the related information control portion.

4. The electronic device according to claim 3, wherein
the first related information includes information related to a shooting condition of the target image, and
the second related information includes information other than the information related to the shooting condition.

5. The electronic device according to claim 4, wherein
the operation input portion can also receive input of additional information, and
when the additional information is input to the electronic device via the operation input portion, the related information control portion adds the additional information to the second related information.

6. The electronic device according to claim 5, wherein
the second predetermined operation includes specification of a position on a display screen in the display portion,
when the second predetermined operation is input to the operation input portion while the target image is being displayed in the specific display region, the display portion displays the second related information in the second partial display region as a display region corresponding to the specified position,
when the input of the additional information is received, the input additional information is displayed on the display portion, the related information control portion holding a display position of the additional information in association with the additional information, and
after the input of the additional information, when the second predetermined operation is input to the operation input portion with a position corresponding to the held position specified while the target image is being displayed in the specific display region, the display portion displays the additional information.

7. The electronic device according to claim 5, wherein
the second predetermined operation includes specification of a position on a display screen in the display portion,
when the second predetermined operation is input to the operation input portion while the target image is being displayed in the specific display region, the display portion displays the second related information in the second partial display region as a display region corresponding to the specified position,
when the input of the additional information is received, the input additional information is displayed on the display portion, and
after the input of the additional information, when the second predetermined operation is input to the operation input portion while the target image is being displayed in the specific display region, irrespective of a display position of the additional information at a time of receipt of the input of the additional information, the display portion displays the second related information including the additional information in the second partial display region.

8. The electronic device according to claim 3, wherein
the display portion includes a touch panel which functions as the operation input portion,
the first predetermined operation is an operation involving contact between the first partial display region and an operating member, and
the second predetermined operation is an operation involving contact between the second partial display region and the operating member.

9. The electronic device according to claim 1, wherein
the operation input portion can also receive input of additional information, and
when the additional information is input to the electronic device via the operation input portion, the related information control portion adds the additional information to the related information.

10. The electronic device according to claim 9, wherein
the predetermined operation includes specification of a position on a display screen in the display portion,
when the predetermined operation is input to the operation input portion while the target image is being displayed in the specific display region, the display portion displays the related information in the partial display region as a display region corresponding to the specified position,
when the input of the additional information is received, the input additional information is displayed on the display portion, the related information control portion holding a display position of the additional information in association with the additional information, and
after the input of the additional information, when the predetermined operation is input to the operation input portion with a position corresponding to the held position specified while the target image is being displayed in the specific display region, the display portion displays the additional information.

11. The electronic device according to claim 9, wherein
the predetermined operation includes specification of a position on a display screen in the display portion,
when the predetermined operation is input to the operation input portion while the target image is being displayed in the specific display region, the display portion displays the related information in the partial display region as a display region corresponding to the specified position,
when the input of the additional information is received, the input additional information is displayed on the display portion, and
after the input of the additional information, when the predetermined operation is input to the operation input portion while the target image is being displayed in the specific display region, irrespective of a display position of the additional information at a time of receipt of the input of the additional information, the display portion displays the related information including the additional information in the partial display region.

12. The electronic device according to claim 1, wherein
the related information includes information related to a shooting condition of the target image.

13. A related information display method for use in an electronic device including a display portion operable to display a target image obtained by shooting and an operation input portion which receives input of a predetermined operation, the method comprising:
a related information acquiring step of acquiring related information associated with the target image; and
a displaying step of displaying, when the predetermined operation is input to the operation input portion while the target image is being displayed in a specific display region on the display portion, the related information in place of a partial image of the target image in a partial display region inside the specific display region,
wherein
the partial display region is composed of a display region inside a first geometrical figure formed by connecting together a first point, a second point, and a third point and a display region inside a second geometrical figure formed by connecting together the second point, the third point, and a fourth point, the related information being displayed in the display region inside the first geometrical figure.

14. A program for making a computer realize the related information display method according to claim 13.
